(19) United States
(12) Patent Application Publication
(10) Pub. No.: US 2002/0129293 A1
(43) Pub. Date: Sep. 12, 2002

(54) Scan based multiple ring oscillator structure for on-chip speed measurement

(76) Inventors: John F. Hutton, Fort Collins, CO (US); William A. Hudson, Fort Collins, CO (US); Daniel L. Halperin, Fort Collins, CO (US); Daniel W. Krueger, Fort Collins, CO (US); Jack T. Lavier, Fort Collins, CO (US); Mark D. Musgrove, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/800,851

(22) Filed: Mar. 7, 2001

(51) Int. Cl. G06F 1/04; G06F 1/06; G06F 1/08

(52) U.S. Cl. 713/500

(57) ABSTRACT

The present invention bundles four ring oscillators, a 20-bit ripple counter and the necessary control logic needed to implement a JTAG scan based interface. The present system can be located on every die, so that each location can be individually tested. It communicates with the outside world through a standard JTAG interface. It is accessible at wafer, package, and system test which allows for several methods of correlating the oscillator speed to the speed of a part in the actual system.

### TECHNICAL FIELD

The technical field is tracking process variations.

### BACKGROUND ART

Ring oscillators are often used in analog parameter testing (APT) structures generated by wafer manufacturers. The manufacturer makes a wafer and different dies sit on the wafer. One important function is to try and optimize the number of dies placed on one wafer. To save space, manufacturers place the APT structures in the area between two dies.

Speed banning is usually done based upon some type of broadside test performed by a package tester. These tests are run by the fabrication which saves the information in a database. Due to the limitations of wafer testing, broadside speed testing is usually delayed until the dies are packaged. Thus, it is often difficult to know the speed of a part at wafer test. There are other ring oscillator structures placed on a chip to attempt to compensate for process variation, however, none of them export their information outside of the chip.

Furthermore, in prior applications, manufacturers “best guess” would be to add an extra five percent here or an extra ten percent here because they believe a particular thing is going to happen or they want to see what is going to occur in the system. This means that some method to get a “best guess” at the speed of the part at wafer test will significantly reduce the price of packaging a part that will not make the frequency cutoff. In addition, several processes make it easy to set the speed at wafer test and difficult to set at package test. Thus, there is a need to measure process variation at wafer, package and system test cycles.

### SUMMARY OF INVENTION

The present invention bundles four ring oscillators, a 20-bit ripple counter and the necessary control logic needed to implement a Joint Test Action Group (JTAG) scan based interface. The present system can be located on every die, so that each location can be individually tested. It communicates with the outside world through a standard JTAG interface. It is accessible at wafer, package, and system test which allows for several methods of correlating the oscillator speed to the speed of a part in the actual system.

Those skilled in the art will appreciate these and other advantages and benefits of various embodiments of the invention upon reading the following detailed description of a preferred embodiment with reference to the below-listed drawings.

### BRIEF DESCRIPTION OF DRAWINGS

FIG. 1 is a diagram showing a scan based multiple ring oscillator structure; and

FIG. 2 is a block diagram implementing the structure of FIG. 1.

### DETAILED DESCRIPTION OF A PREFERRED EMBODIMENT

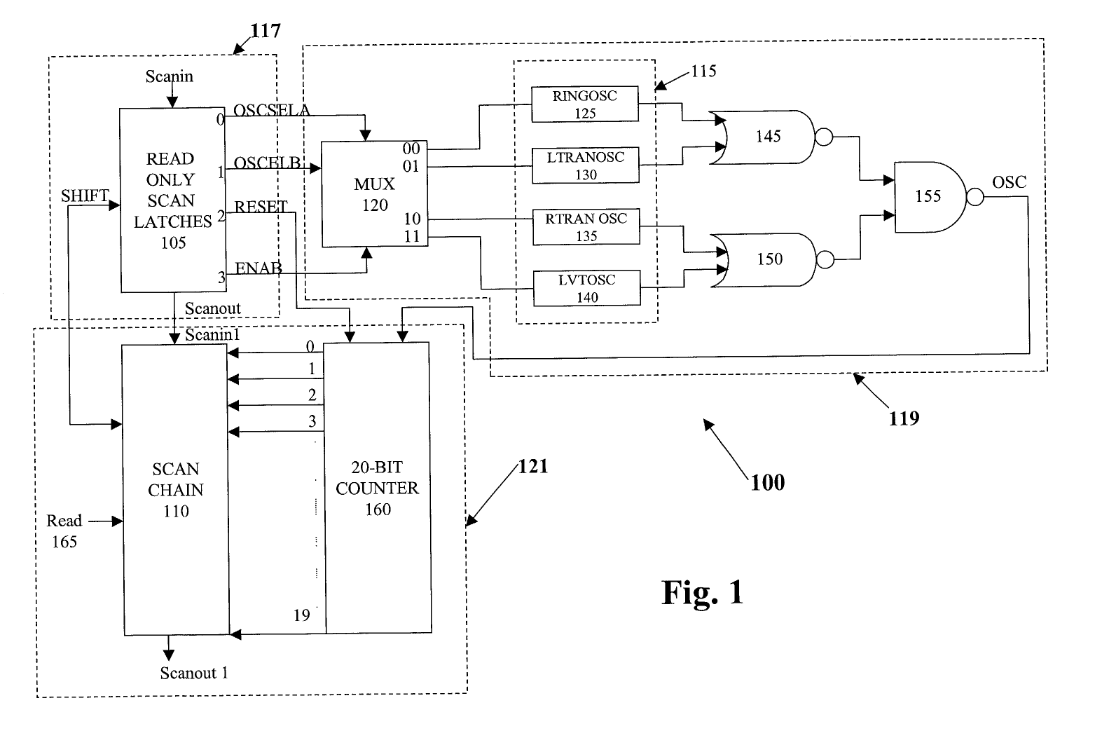

FIG. 1 illustrates a system 100 that tracks process variations. Circuit 117 includes read only scan latches 105 that contain four control bits. The function of the circuit is for clock and count control. The circuit 117 controls which one of the clocks is going to run. The four control bits of the scan latches are BIT 0—OSCSELA, BIT 1—OSCSELB, BIT 2—RESET and BIT3—ENAB. In addition to the four control bits, the scan latches 105 also includes two inputs signals: SHIFT clock and SCAN IN, and an output signal SCAN OUT.

Circuit 121 includes scan chain 110 that contains 20 scan bits used to scan out a final count of a 20-bit counter 160. The function of circuit 121 is to count the clock and capture the count onto the scan chain 110. The system 100 uses the SHIFT signal to transfer all the data into scan latches 105 and out of the scan chain 110. By controlling the SCANIN signal in conjunction with the SHIFT signal, control bits can be loaded into the scan latches 105 or results readout from SCANOUT1 from scan chain 110. Reset circuitry exists to ensure that the manufacturer does not power on a chip with one of the oscillators 115 running.

Circuit 119 selects one of the clocks to input to the 20-bit counter 160. Once the manufacturer uses the SHIFT and the SCANIN signals to set OSCSELA and OSCSELB, multiplexer 120 will turn on the appropriate ring oscillator 115. If OSCSEL A0 and OSCSEL B0 are selected, RING oscillator 125 will be enabled by the ENAB signal. If OSCSEL A0 and OSCSEL B1 are selected, LTRAN oscillator 130 will be enabled. If OSCSEL A1 and OSCSEL B0 are selected, RTRAN oscillator 135 will be enabled. If OSCSEL A1 and OSCSEL B1 are selected, LVT oscillator 140 will be enabled. The oscillators 115 are built from FET structures. Each FET has a FET capacitor type load to allow a reasonable frequency with a low number of stages. By having two control bits select the oscillator, the manufacturer can run one and only one of the oscillators 115 at a time.

The outputs of the RING oscillator 125 and the LTRAN oscillator 130 feeds into NOR gate 145. The outputs of the RTRAN oscillator 135 and the LVT oscillator 140 feeds into NOR gate 150. The outputs of both the NOR gates 145 and 150 feed into a NAND gate 155. The output of the NAND gate 155 is an OSC signal which is the input to a 20-bit counter 160. The OSC signal is a clock signal. The counter 160 increments by one count every time the clock ticks. Once the manufacturer has the count they can run a READ signal 165 in the scan chain that transfers the number of times the selected oscillator toggled during the test time into the scan chain 110. Once in the scan chain 110, subsequent SHIFT clocks scan the number out through SCAN OUT1. Scanout and Scanin1 simply connect circuit 117 and circuit 121 to make one continuous scan chain. There can only be one input signal and one output signal for this to be considered a single chain. The other input to the 20-bit counter 160 is the RESET signal from the read only scan latches 105. The RESET signal resets the counter 160 to zero before powering. The counter 160 is a ripple counter with an asynchronous reset.

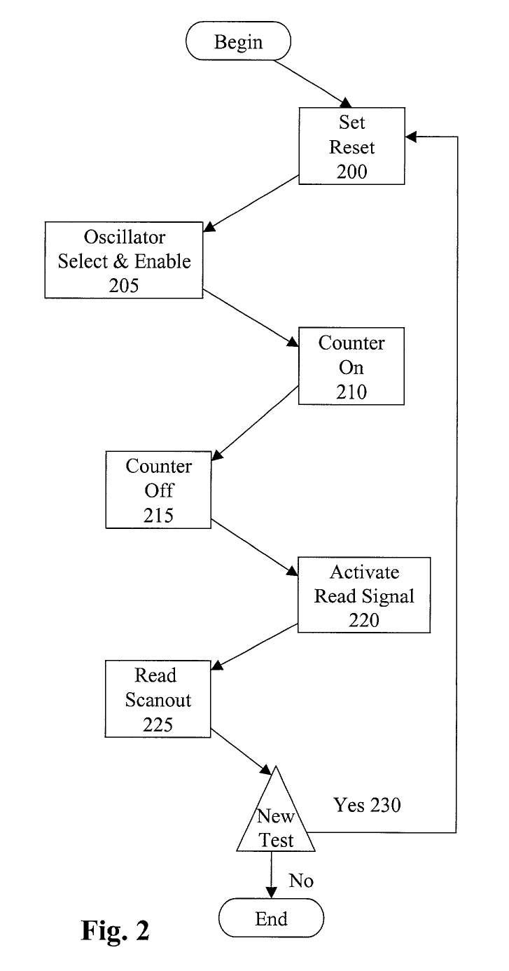

FIG. 2 is a flow chart implementing the structure described in FIG. 1. The system intially sets the RESET signal to be on (step 200). By controlling the SCANIN signal and toggling the SHIFT clock this sets the RESET bit to be on. Next, the system selects and enables an oscillator (step 205). The manufacturer uses the SHIFT clock and SCANIN to set the proper bits in OSCSELA and OSCSELB and turn on the ENAB signal. In addition, the RESET bit is now turned off. In order to start count, the SHIFT clock is toggled once (step 210) and then the SHIFT clock is toggled again to stop the count (step 215). The time period between toggling the SHIFT clock on and toggling the SHIFT clock off indicates the test time. The first count is loaded in BIT 0 of the counter 160. The next count will move the value in BIT 0 to BIT 1 and place the new value into BIT 0. The toggling of the SHIFT clock will load up the counter 160. Once the counter is loaded, the READ signal is activated to transfer the count into the scan chain 110 (step 220). The SHIFT clock is toggled once more and the results of the scan in are read out of SCANOUT1 (step 225). Next the designer decides if a new test needs to be conducted. If a new is conducted (step 230), the RESET bit is turned on. Otherwise, the system has completed the test (step 235).

The present invention does not necessarily require any other control structures. The manufacturer does not have to actually be executing code on the CPU, rather all the manufacturer needs is access to the three pins to turn on the ring oscillator to count it, turn it off and then scan out the count and then do calculation and software to find out how fast it would work. JTAG accessibility and all of the control structure set up to use the JTAG functionality make it very usable.

In the present invention, the system 100 enables manufactures to initially test the wafer before the dies are cut apart. This allows the manufactures to know of any defects on the wafer before cutting it apart. If there is a defect, the manufacturer does not cut up that particular wafer, however, upon testing, the wafer is good, the manufacturer cuts apart the wafer into separate dies. Now the manufacturer can test each individual die prior to packaging. Thus, the present invention allows the manufacturer to have access at wafer, package or system test life cycle.

By having access at the various test cycles, the sooner the manufacturer knows of the defect, the more money the manufacturer saves. If the manufacturer can find a defect at wafer, then the manufacturer does not have to put it into a package and spend hundreds of dollars to get into a package when they can throw it away immediately. Furthermore, if there is away the manufacturer can put parts into a system and easily find out what the ring oscillator does in the system, what it does in the package test and what it does at wafer test, then the manufacturer can correlate that to how fast the manufacturer can actually run that part in the system. This information gives the manufacturer a real good focus on what they have to do to the wafer to be able to have the part run properly in the system. Therefore, it allows the manufacturer to take data in the system test and easily apply it back to the wafer test for manufacturing.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated.

What is claimed is:

1. A method for detecting process variations, the method comprising the steps of:
controlling count gate control by a first circuit;
generating at least one clock count by a second circuit; and
outputting results of the clock count by a third circuit.

2. The method of claim 1, wherein the step of controlling comprises the steps of:
activating a scan signal;
toggling a clock signal; and
setting a reset signal on.

3. The method of claim 2, wherein the step of controlling further comprises the steps of:
selecting an oscillator by activating and toggling the signals;
enabling the oscillator; and
setting the reset signal off.

4. The method of claim 2, wherein the step of controlling further comprises the step of toggling the clock signal for a period of time.

5. The method of claim 1, wherein the step of generating further comprises the steps of:
outputting the count into a counter; and
reading the count into a scan chain.

6. The method of claim 4, wherein the step of toggling further comprises the step of storing the output of the toggle in a counter.

7. The method of claim 5, further comprises the step of toggling the clock for reading out the clock count.

8. The method of claim 1, further comprising the step of communicating with a JTAG interface.

9. The method of claim 4, further comprises the step of communicating with a JTAG interface.

10. An apparatus to detect process variations comprising:
a first circuit to select a clock;
a second circuit connected to the first circuit to generate at least one clock count; and
a third circuit connected to the first circuit to output a result of the clock count.

11. The apparatus of claim 10, wherein the first circuit comprises:
a scan signal; and
a clock signal, wherein the scan signal and the clock signal turn on at least one clock.

12. The apparatus of claim 11, wherein the first circuit further comprises:
a reset signal; and
an enable signal, wherein the enable signal enables the at least one clock.

13. The apparatus of claim 11, wherein the clock signal is toggled for a period of time.

14. The apparatus of claim 13, wherein the second circuit further comprises outputting a count of the toggle.

15. The apparatus of claim 14, wherein the third circuit comprises:
a counter; and
a scan chain, wherein the scan chain is connected to the counter.

16. The apparatus of claim 15, wherein the count is input to the counter.

17. The apparatus of claim 15, wherein the reset signal is input to the counter.

18. The apparatus of claim 16, wherein the scan chain further comprises a read signal, wherein the read signal reads the count into the scan chain.

19. The apparatus of claim 18, wherein the clock signal is toggled to read out the count from the scan chain.

20. The apparatus of claim 10, wherein communicates with a JTAG interface.
